(19) United States
(12) Patent Application Publication
(10) Pub. No.: US 2013/0078109 A1
(43) Pub. Date: Mar. 28, 2013

(54) OFFSHORE WIND TURBINE STRUCTURES AND METHODS THEREFOR

(71) Applicant: Herman J. Schellstede, New Iberia, LA (US)

(72) Inventor: Herman J. Schellstede, New Iberia, LA (US)

(73) Assignee: GRAND VENT POWER, LLC, Houston, TX (US)

(21) Appl. No.: 13/684,491

(22) Filed: Nov. 23, 2012

Related U.S. Application Data
(63) Continuation of application No. 11/687,624, filed on Mar. 16, 2007, now abandoned.
(60) Provisional application No. 60/783,647, filed on Mar. 17, 2006.

(51) Int. Cl. F03D 11/04

(52) U.S. Cl. CPC F03D 11/045
USPC 416/244 R

(57) ABSTRACT

Structures and methods for elevating and retracting offshore wind turbine assemblies. Structures and methods are presented for elevating and retracting offshore wind turbine assemblies mounted on a tower in order to facilitate both service of the assemblies at any time, as well as preservation of the assemblies through storms or other high-wind weather events. Among the structures presented are folding wind turbine blades that may be folded into compact clusters and secured to braces in order to minimize damage during storms or other high-wind events.

### CROSS-REFERENCE TO RELATED APPLICATIONS

This application for patent is a continuation of U.S. Non-Provisional application Ser. No. 11/687,624 of the same title and filed Mar. 16, 2007; and claims the benefit of U.S. Provisional Application Ser. No. 60/783,647 of the same title and filed Mar. 17, 2006, both of which are incorporated herein by reference. This application additionally incorporates two applications by reference: PCT/U.S. 2005/015973 (WO 2005/107425: “Offshore Windmill Electric Generator”), filed May 6, 2005, and its parent U.S. Provisional Application Ser. No. 60/569,077, filed May 6, 2004.

### BACKGROUND

Wind velocities are generally increased at higher elevations. In order to maximize the capture of energy from winds blowing over, for example, ocean water, mounting wind turbines at elevated levels (e.g., between 200 to 500 feet above sea level) on tower structures is generally desirable. However, a commercial or industrial wind turbine generator and its housing typically form a massive unit (e.g., having an average weight of 70 tons). Marine equipment capable of lifting a 70 ton wind turbine generator unit for mounting on a tower structure 200 to 500 feet above sea level is extremely expensive. Embodiments disclosed herein bypass the need to use such expensive equipment.

### SUMMARY

Various disclosed embodiments facilitate the operation at various locations, including offshore locations, of wind turbine generators on towers capable of being elevated and retracted. A wind turbine generator may be mounted (and serviced) on such a tower with relative ease when the tower is in a retracted or service mode configuration. In particular, various disclosed embodiments relate generally to structures and methods for elevating a wind turbine into winds that blow at higher levels than sea level (e.g., typically 200 feet or more above sea level) in order to facilitate the turbine's capture of kinetic energy from the wind. Other disclosed embodiments relate generally to structures and methods for retracting a wind turbine from elevated levels in order to service the wind turbine, as well as to protect it from storm damage. Commonly the wind turbine is an offshore wind turbine. Some disclosed embodiments further relate generally to structures and methods for unfolding blades of a wind turbine from a compact cluster into a balanced, extended blade arrangement in order to put the turbine in a condition for harvesting wind energy. Other disclosed embodiments further relate generally to structures and methods for folding blades (typically at least two of three blades) of a wind turbine into a compact cluster in order to protect the blades (and the turbine) from damage during storms or other high-wind weather events.

### BRIEF DESCRIPTION OF THE DRAWINGS

The foregoing and other advantages will become apparent from the following detailed description and upon reference to the drawings, wherein:

FIG. 1 illustrates a wind turbine generator mounted on a support tower that is in an extended or operating mode configuration; the tower extends from the ocean floor to a height some distance above sea level;

FIG. 2A illustrates a tower that is in a retracted or service mode configuration, and

FIG. 2B illustrates three different tower configurations (the left tower is in an extended or operating mode configuration, the center tower is in a retracted or service mode configuration, and the right tower is in a storm mode configuration);

FIG. 3A (side view) and FIG. 3B (cross section at A-A of FIG. 3A) illustrate a tubular member of a tower; standard gear racks are welded to the tubular member;

FIG. 4A illustrates the mounting of a turbine assembly on a tower that is in a retracted or service mode configuration; FIGS. 4B-40 illustrate various tower embodiments;

FIG. 5 illustrates a locking assembly located at a lower end of a movable tubular member of the tower;

FIG. 6 illustrates a tower power train that includes a pinion gear, a gear reducer and a hydraulic motor;

FIG. 7 illustrates a service vessel equipped with a hydraulic power source; hydraulic power lines from the service vessel connect to hydraulic motors on the elevator tower;

FIG. 8 illustrates a hinge point assembly of a folding blade wherein the folding blade is in an extended position (i.e., in an operating mode position);

FIG. 9 illustrates a hinge point assembly of a folding blade wherein the folding blade is in a folded position (e.g. in a storm mode position);

FIG. 10 illustrates a compact cluster of folded blades with tips attached to a storm brace (e.g., where the cluster of folded blades is in a storm mode configuration); and

FIG. 11 illustrates a bore hole (i.e., stinger hole) into which the lower end of sealed caisson of a tower may be placed.

### DETAILED DESCRIPTION

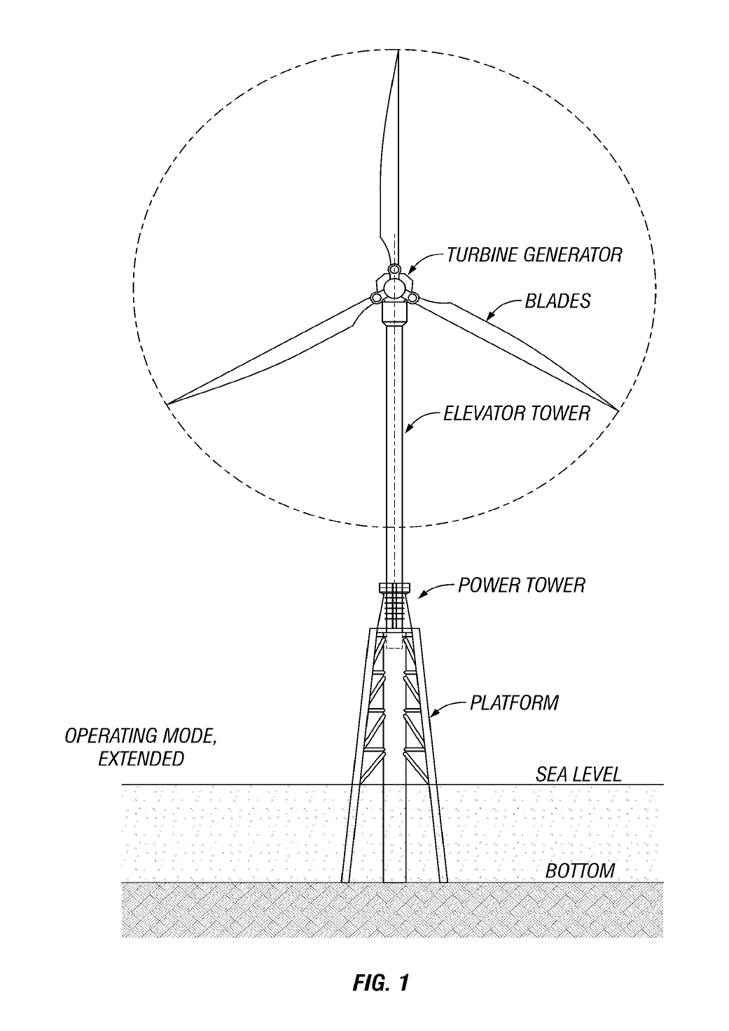

Referring to FIG. 1, three blades attach to a wind turbine generator mounted on a tower that is in an extended or operating mode configuration. As noted previously in Application PCT/U.S. 2005/015973, wind machines typically have three major components: 1) a variable pitch, usually three-bladed fan; 2) a generation system with a gearbox and mounting means usually housed in a nacelle; and 3) a support tower. In the depicted embodiment, the tower extends upward from a platform that stands on the ocean bottom. The tower elevates the fan and turbine generator some distance above sea level. In other embodiments, the tower may extend from a base that is submerged, but instead of standing on an ocean bottom, is buoyant. In still other embodiments, the tower may extend from a base that stands on dry land.

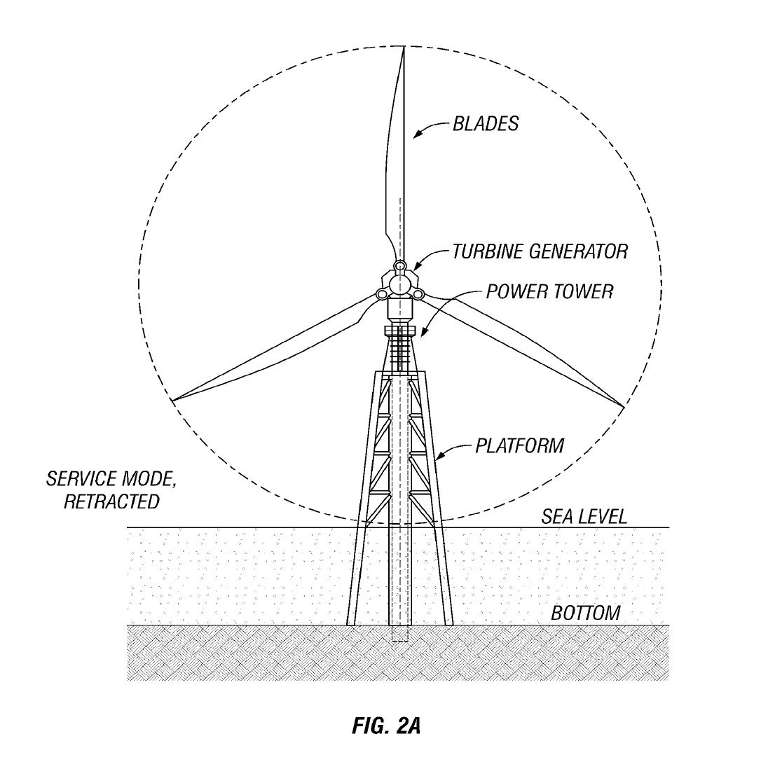

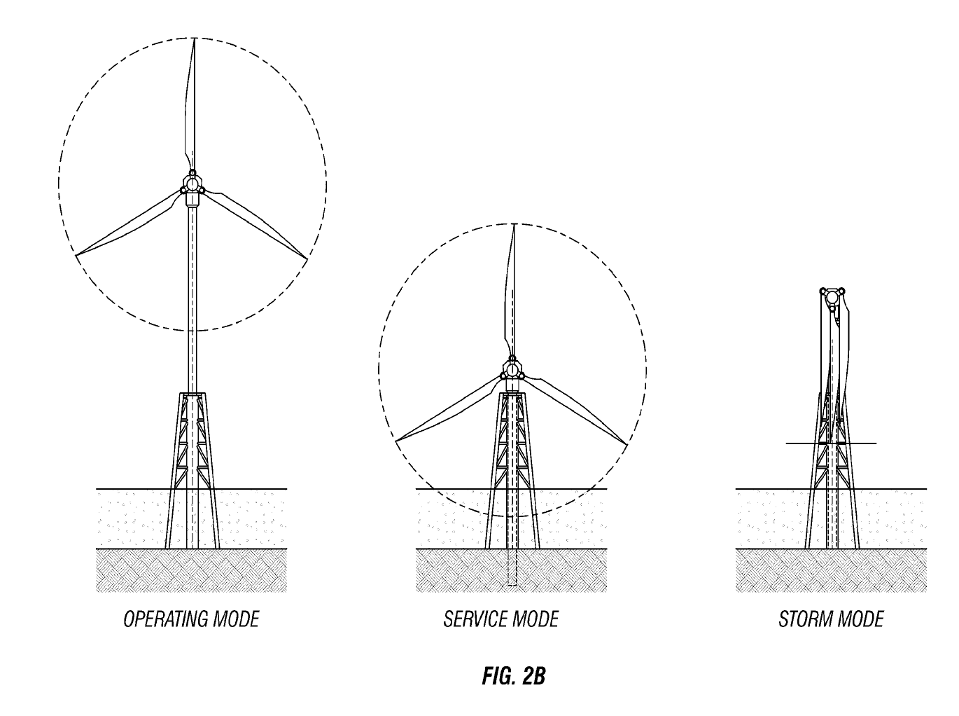

Referring to FIG. 2A, the depicted tower is in a retracted or service mode configuration. In this embodiment, the bounds of the circle defined by the path of the ends of the fan blades approach the ocean surface. The fan blades and turbine generator can typically be mounted or serviced more easily when the tower is in a retracted or service mode configuration than when the tower is in an extended or operating mode configuration. In particular, when a wind machine that is located offshore is in such a retracted or service mode configuration, low-cost marine equipment (or at least standard-cost marine equipment, instead of high-cost marine equipment) may be utilized to access the fan blades, the turbine generator and other nearby components of the wind machine.

Referring to FIG. 2B, a comparison of towers in three different configurations highlights that the blades of a tower in a storm mode configuration (as depicted on the right) are folded into a compact cluster. To the degree that folding of blades identifies a storm mode configuration, only two of the three blades must be in a folded position in order for a tower carrying a three-blade fan to be placed in a storm mode configuration.

Wind machines are commonly equipped with three blades that are designed to rotate a turbine drive shaft so as to maximize the capture of kinetic energy from the wind. Blades are typically not fixed in attitude but may be adjusted while in use in order to maximize energy capture at various wind velocities. Blades made of fiberglass and carbon fiber materials in cantilever beam designs are common. Length-to-depth ratios are typically quite large, which results in slender structural members. Contemporary wind turbines can produce a sweep area from 200 feet to 400 feet in diameter. Blades of three-blade fans are spaced 120.degree.apart, and the blades will tolerate storm winds up to certain velocities. However, blade vibration at certain harmonic levels yet occurs and can cause blade failure.

The capacity of blades to be folded into a compact cluster (as in disclosed embodiments) in particular allows blade outer tips to be secured. Blade vibration during storm gusts can thus be dampened and blade failure avoided. The capacity for blades to be folded into a compact cluster, as well as for blade outer tips to be secured during storage, greatly facilitates the survival through storms of blades and associated equipment.

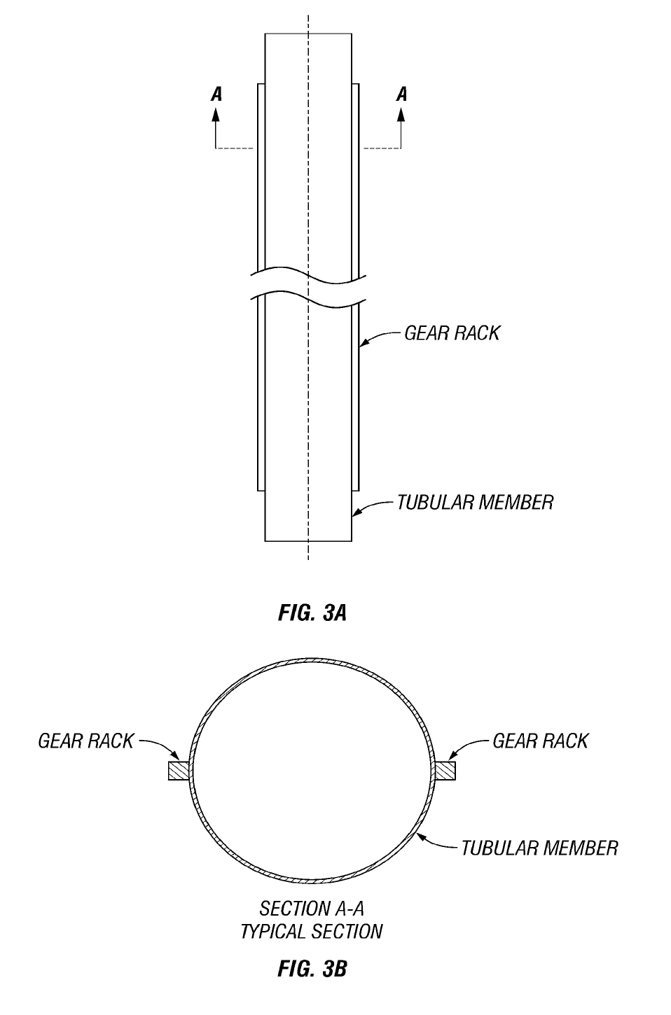

Referring to FIG. 3A, a side view of a tubular member of a typical tower assembly reveals that standard gear racks are welded on sides of the tubular member. The gear racks are used as means to elevate (and lower) a turbine generator mounted on the tower. Referring to

FIG. 3B, a cross-section of a tubular member at plane A-A of FIG. 3A reveals that the gear racks are welded on the sides of the tubular member at positions 180 degree opposite each other. The cross-section further reveals the tubular member to be generally circular, and the gear racks to be generally rectangular, although these cross-sectional shapes may vary in other embodiments.

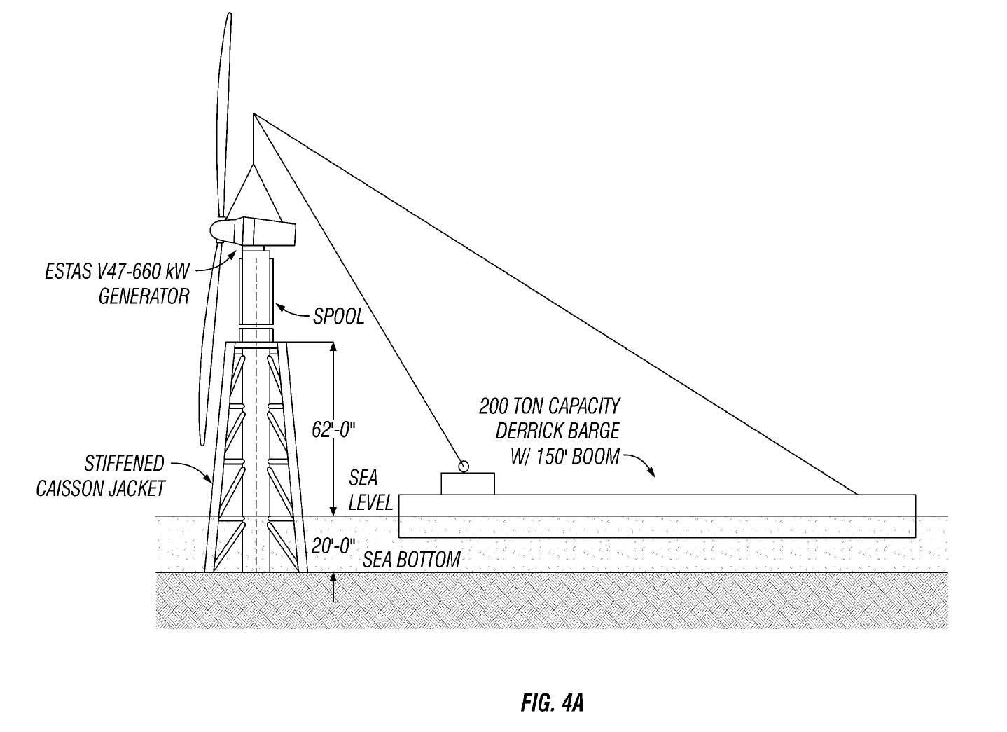

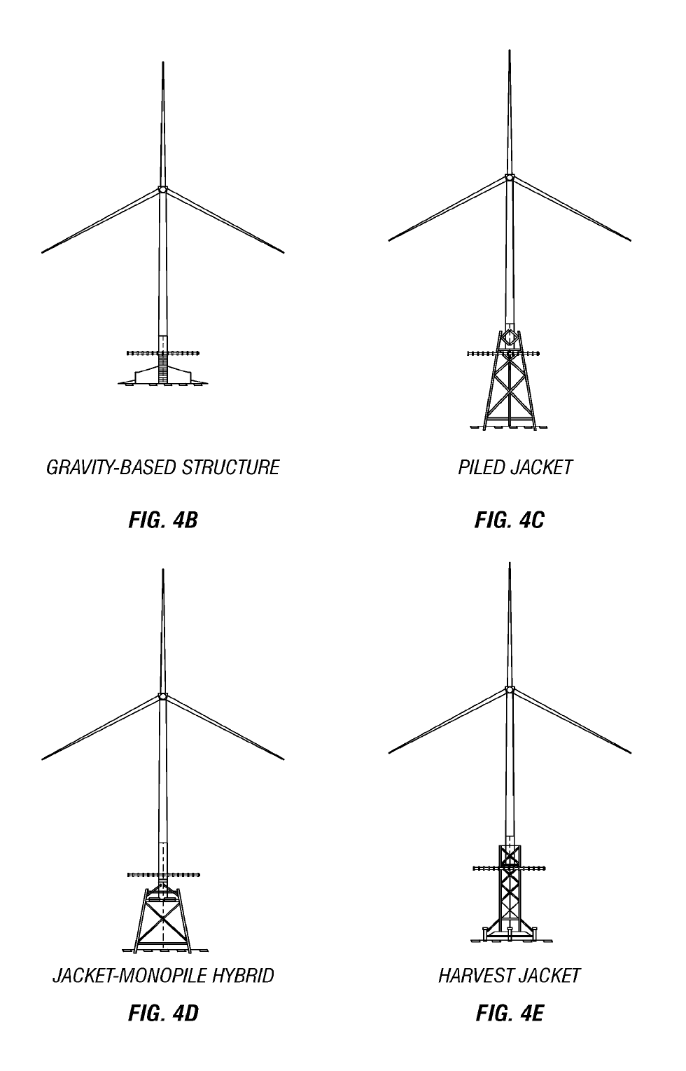

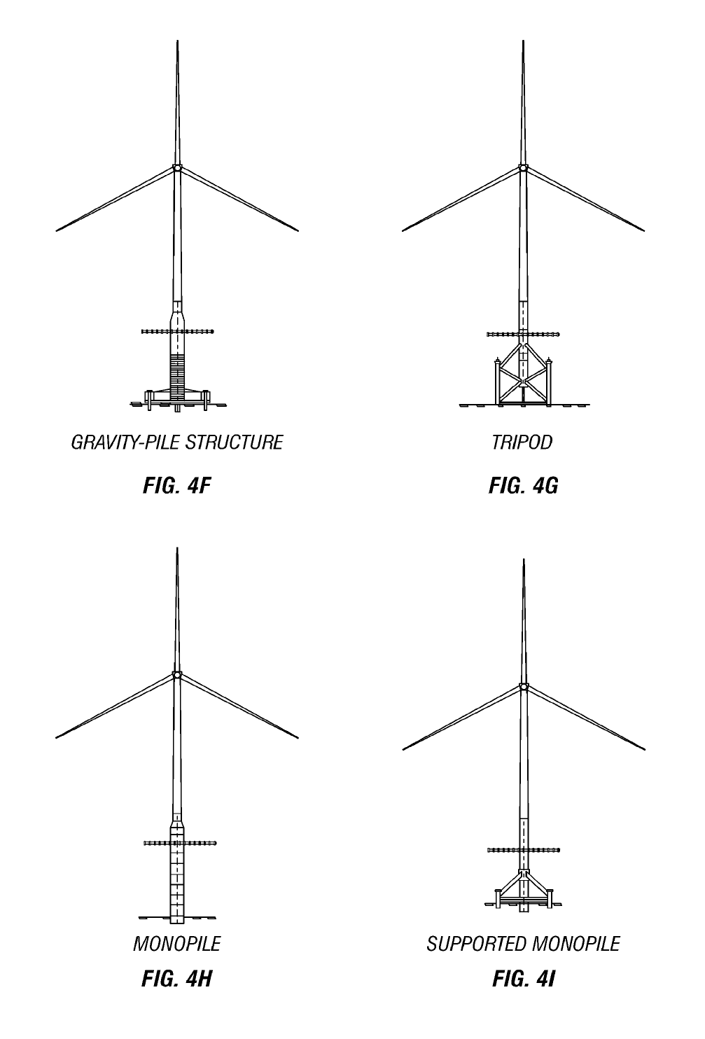

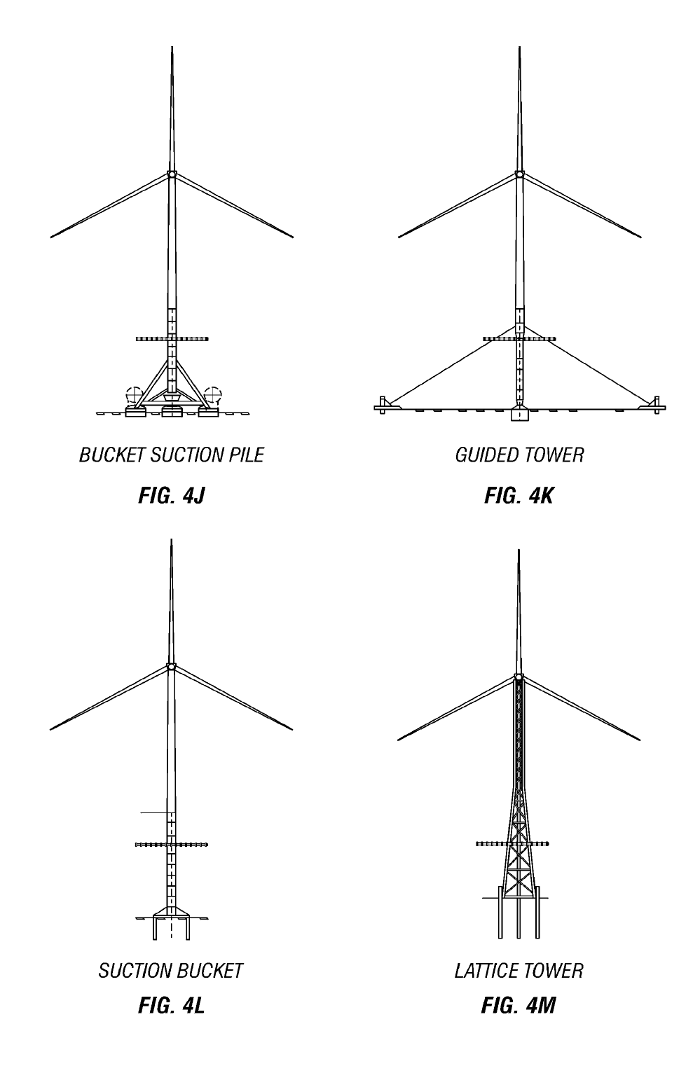

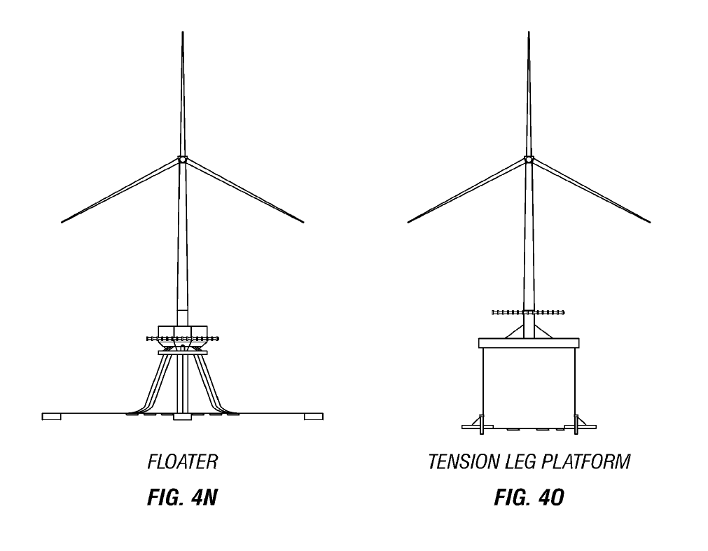

Referring to FIG. 4A, a 200-ton capacity derrick barge with a 150-foot boom may be used to mount a VESTAS® (Vestas Wind Systems A/S, Randers, Denmark; see also www.vestas.com) V47-660 kW generator on a tower that is in a retracted or service mode configuration. Needless to say, calm seas are preferred for the accomplishment of such an operation.

Before a generator is mounted on a tower, the tower itself is assembled and, in the embodiment depicted in FIG. 4A, placed on the ocean floor. The platform section of the tower depicted in FIG. 4A includes stiffened caisson jackets that extend from the ocean floor upward though 20 feet of water to a height of 62 feet above sea level. A spool capable of rotating 360 degrees is attached on top of a tubular member, which only partially extends from a central region or structure of the platform section of the tower in this embodiment. A small, inexpensive lift boat or derrick barge can then be used to install the turbine and blade assembly on the spool of the tower when the tower is in a retracted or service mode configuration.

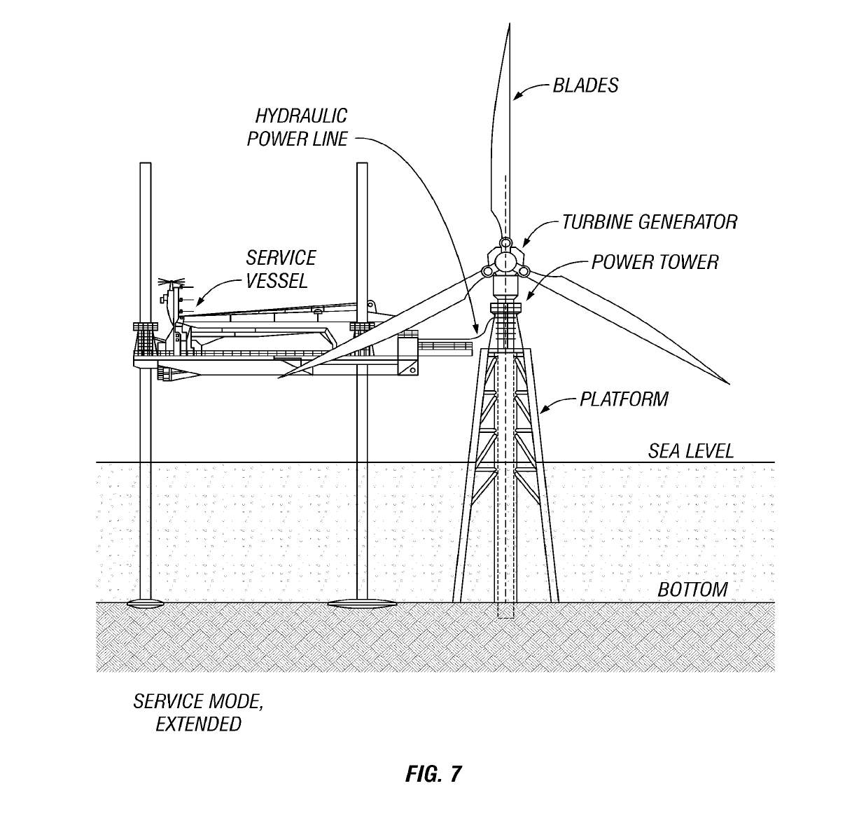

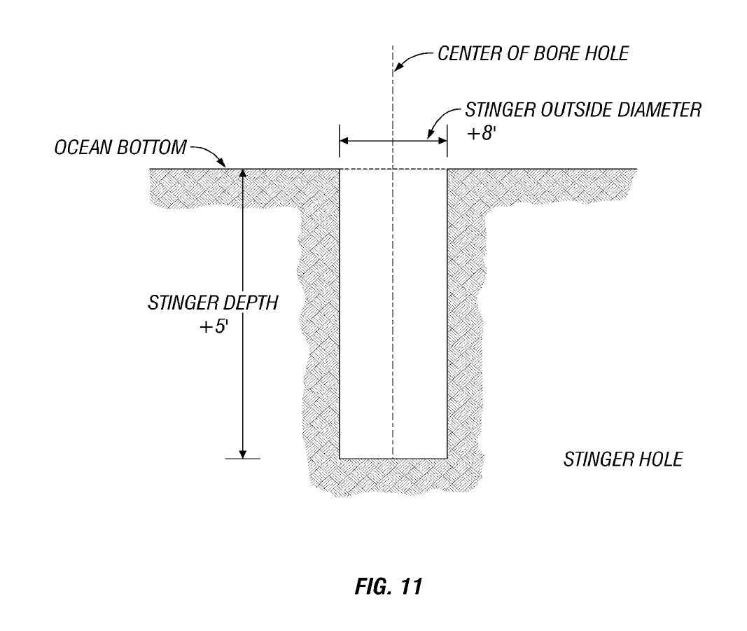

In some embodiments similar to the embodiment depicted in FIG. 4A, the bottom of a central caisson is sealed and provides a protective, water-excluding environment for the lower end of the tubular member of an extension tower. In some embodiments, the caisson is longer than a support jacket, so that the caisson extends below the mudline into the seabed (see FIG. 2A and FIG. 7). In preparing a location for the installation of a tower having a central caisson of this kind, a void slightly larger in diameter than the diameter of the caisson is prepared in the seabed to an appropriate depth. After the sealed caisson has been placed in the prepared void (i.e., bore hole or stinger hole; see FIG. 11) and its placement set (e.g., by filling surviving void spaces with previously excavated material), the sealed caisson contributes to the stability of the tower platform despite water turbulence that is often associated with an ocean environment. In the depicted embodiment, four pilings that each had been driven into the seabed are located at the corners of the tower platform. These pilings markedly further enhance the stability of the tower platform.

Referring to FIGS. 4B-40, various tower embodiments are illustrated. Each of these tower embodiments may be identified by a descriptive name, as follows: TABLE-US-00001 FIG. Tower Descriptive Name 4B Gravity-based structure 4C Piled jacket 4D Jacket-monopile hybrid 4E Harvest jacket 4F Gravity-pile structure 4G Tripod 4H Monopile 41 Supported monopile 4J Bucket suction pile 4K Guided tower 4L Suction bucket 4M Lattice tower 4N Floater 40 Tension leg platform

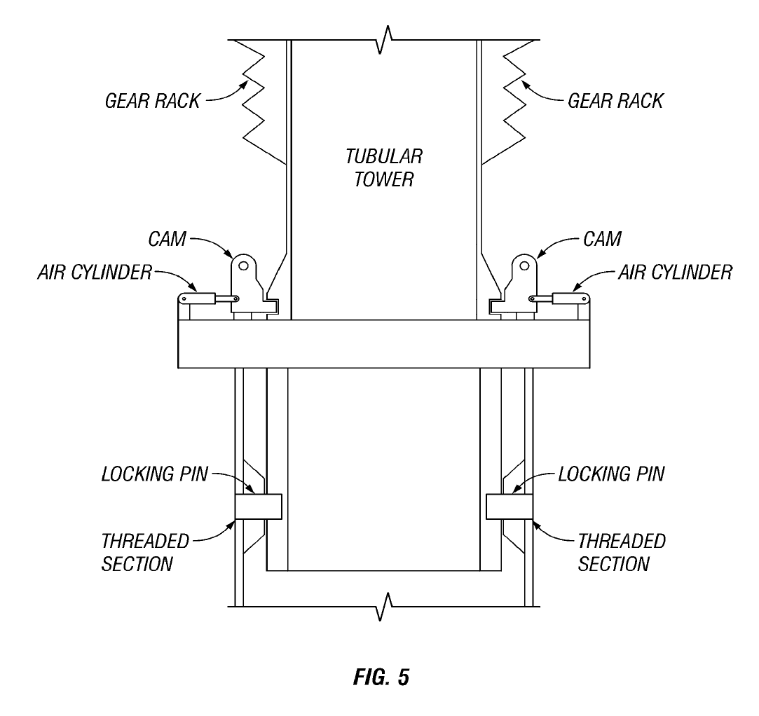

Referring to FIG. 5, on at least two sides (at positions 180 degrees opposite each other), a threaded section with a locking pin assembly joins to a movable tubular member at a lower end of a tower. Above each locking pin assembly, a cam-anchored latch (controlled by an air cylinder) fits into a groove of a track. Each latch is located below each of the gear racks that is welded to the tubular member, and each locking pin and latch (or pall assembly) secures the tubular member of the elevator tower to the central region or structure of the platform section of the tower in this embodiment. At the same time, each pall assembly aligns the tubular member within that central region. Though two pall assemblies are shown, additional assemblies in various spacing arrangements may be used (e.g., in order to provide more secure connections or to improve alignments between tower components).

Each pall assembly is of machine-tool quality. The use in various embodiments of pall assemblies represents a significant improvement over the traditional use of bolts (e.g., in a series) to secure tower sections to each other. In particular, the use of pall assemblies allows an operator to lock (or unlock) an elevator tower for re-positioning with greater ease than would be possible if bolts were used to secure tower sections to each other.

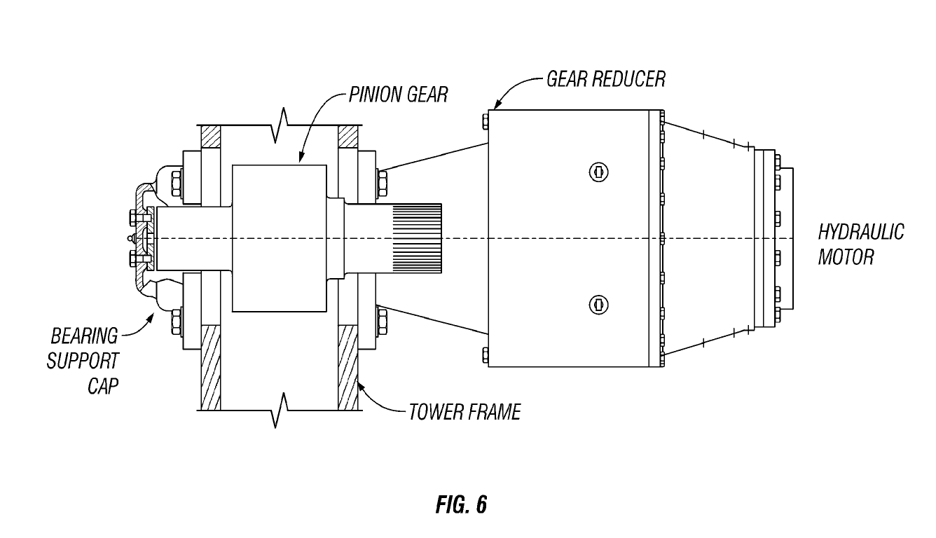

Referring to FIG. 6, a hydraulic motor in a power train powers the elevation or retraction of an elevator tower (i.e., in this embodiment, by elevation or retraction of a tubular member). The hydraulic motor acts via a gear reducer (i.e., transmission) and a pinion gear to drive cogs that intercalate with ridges on each gear rack that is welded to a side of the tubular member. By means of a control panel (not shown), an operator may regulate the flow through hydraulic lines of hydraulic fluid into the motor. In this way, an operator may control movement (e.g., elevation or retraction) of the elevator tower. Depending on settings chosen by the operator, the hydraulic motor may power the elevator tower to move upward at various slow speeds (e.g., from 50 to 120 feet per hour). As the tower nears its full extension, the speed of the tower's upward movement is reduced in order to allow the locking assemblies to be engaged or activated.

Because the engagement of locking assemblies is positive, an operator can activate hydraulic cylinders to release the engagement if, for example, the operator wishes to retract the elevator tower. An elevator tower generally can be retracted from an extended or operating mode configuration to a retracted or service mode configuration in less than 90 minutes. The capacity of embodiments to be converted relatively quickly from an extended or operating mode configuration to a retracted or service mode configuration facilitates maintaining (or upgrading) a turbine and blade assembly. Because embodiments can similarly be converted relatively quickly to a storm mode configuration, the protection of turbine and blade assemblies is similarly facilitated. Other elevator tower embodiments may borrow structures from oilfield jackup rig assemblies known to those of skill in the art in view of the present disclosure.

In some embodiments, a hydraulic power source is located on the maintenance jackup vessel. Because use of the hydraulic cylinders and jacking system to lower or raise tower structures may occur only two (or fewer) times per year, a hydraulic power source need not be maintained on the tower (e.g., aboard a tower platform). Rather, a hydraulic power source may be mounted on the deck of a maintenance barge, and hydraulic hoses may be connected from the hydraulic power source on the maintenance barge to a hydraulic motor system associated with the tower. In order to facilitate the control of a tower hydraulic motor system by on operator on the maintenance barge, directional controls for the hydraulic motor system may also be located on the maintenance barge (e.g., near or on the hydraulic power source assembly).

Referring to FIG. 7, a service vessel can be raised on poles to an elevated level near that of a turbine generator mounted on an elevator tower. Hydraulic power lines from the service vessel equipped with a hydraulic power source connect to hydraulic motors on the elevator tower. By controlling the hydraulic power source, an operator on the service vessel may control the elevation or retraction of the elevator tower.

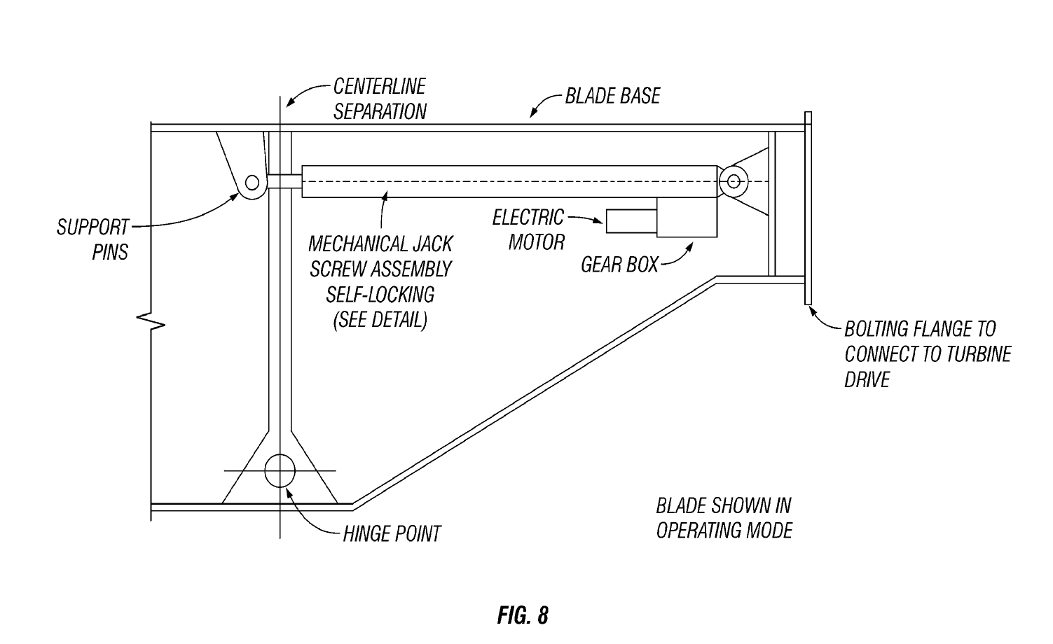

Referring to FIG. 8, a mechanical (self-locking) jack screw assembly in a contracted position minimizes any centerline separation between a blade base and a pivoting blade extension (i.e., in an operating mode position). A hinge point joins the blade base to a corresponding pivoting blade extension independent of whether the mechanical jack screw assembly is in a contracted or an extended position. An electric motor (or, in other embodiments, another source of power for extending the mechanical jack assembly) is connected via a gear box to the mechanical jack assembly in the blade base.

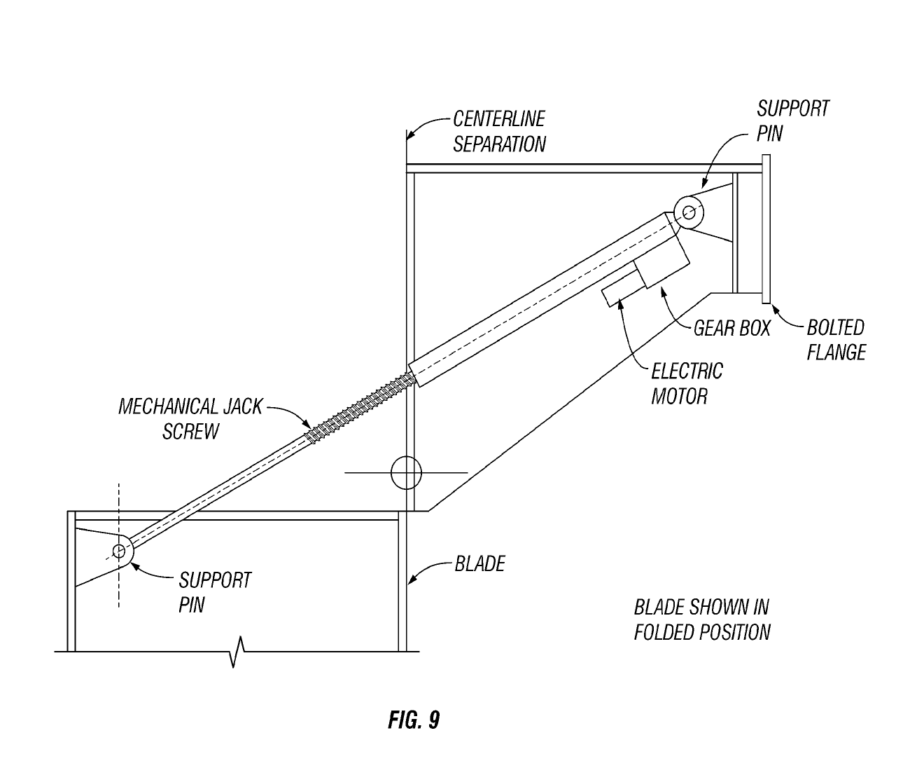

Referring to FIG. 9, a mechanical (self-locking) jack screw assembly in an expanded position generates centerline separation (e.g., of about 90 degrees in the illustrated example) between a blade base and a pivoting blade extension in a folded position (e.g., a storm mode position). The electric motor connected via a gear box to the mechanical jack assembly in the blade base has rotated components of the jack screw assembly so as to generate centerline separation between the blade base and the pivoting blade extension.

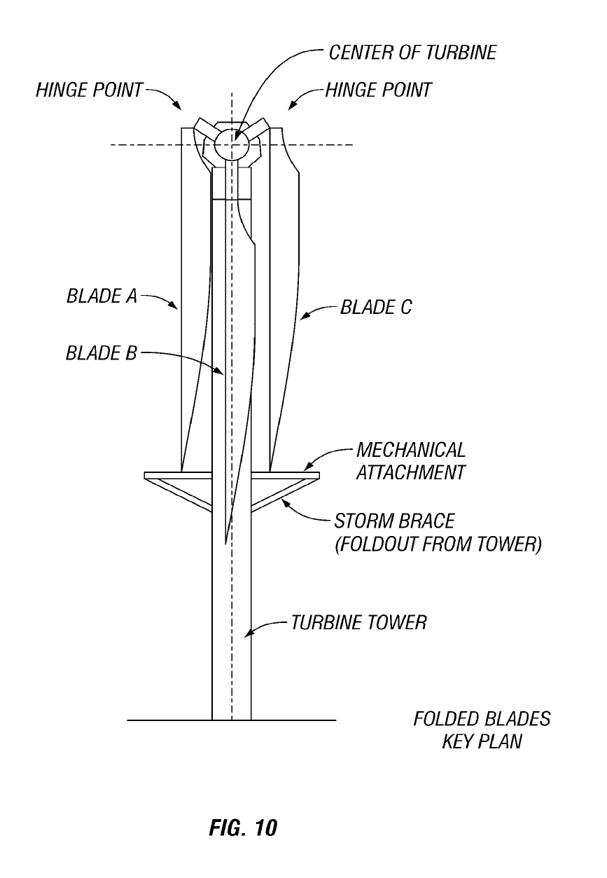

Referring to FIG. 10, a compact cluster of folded blades with tips attached to a storm brace (i.e., a cluster of blades in a storm mode configuration) is collapsed around a turbine tower. The centerline separation that is present between a blade base and an associated pivoting blade extension for at least two hinge points (e.g., of blades A and C) need not be present for the third hinge point (e.g., of blade B, which is already in a position parallel to the vertical tower that supports the turbine). As noted previously, the capacity of blades to be folded into a compact cluster in particular allows blade outer tips to be secured (e.g., to a storm brace that folds out from the tower that supports the wind turbine) and, accordingly, allows blade vibration during storm gusts to be dampened. The capacity for blades to be folded into a compact cluster, as well as for blade outer tips to be secured during storage (e.g., when a cluster of blades is in a storm mode configuration) thus greatly facilitates the survival through storms of blades and associated equipment.

Referring to FIG. 11, a typical stinger hole (i.e., a bore hole in the seabed) is illustrated. In some embodiments, a sealed caisson of the lower end of an extension tower is placed in the stinger hole. As previously noted, having a sealed caisson set in the seabed contributes to the stability of the tower platform.

Following long-standing patent law convention, the terms “a” and “an” mean “one or more” when used in this application, including the claims. Even though embodiments have been described with a certain degree of particularity, it is evident that many alternatives, modifications, and variations will be apparent to those skilled in the art in light of the present disclosure. For example, a person of ordinary skill in the art may see, in the light of the present disclosure, other assembly arrangements that may be used to accomplish tower elevation and retraction as well as other structures and methods for blade folding and unfolding. Accordingly, it is intended that all such alternatives, modifications, and variations which fall within the spirit and scope of the described embodiments be embraced by the defined claims.

What is claimed is:

1. A tower for supporting a wind turbine, wherein the tower may be elevated or retracted, the tower comprising:
a platform with an upper central structure and a lower outboard structure disposed a predefined lateral distance away from a centerline of the platform, the lower outboard structure supporting substantially all the weight of the wind turbine, wherein the upper central structure is a sealed caisson extending below a mudline and into a void in the seabed under the platform;
a movable tubular member, wherein the movable tubular member may be extended from the upper central structure and the void, when in an elevated operating mode, and wherein the movable tubular member may be retracted into the upper central structure and the void in the seabed, when in a retracted service mode, such that at least a portion of the movable tubular member is located below the mudline in the retracted service mode; and
a locking assembly capable of maintaining an attachment or an alignment between the movable tubular member and the upper central structure.

2. The tower of claim 1, wherein a gear rack is attached to the movable tubular member.

3. The tower of claim 1, wherein the locking assembly comprises a pall assembly.

4. The tower of claim 1 on which a wind turbine is mounted.

5. The tower of claim 1, further comprising a hydraulic motor that powers elevation or retraction of the movable tubular member.

6. The tower of claim 5, wherein hydraulic power is provided to the hydraulic motor through hydraulic lines from a service vessel.

7. The tower of claim 1, wherein a lower end of the upper central structure is a sealed caisson.

8. The tower of claim 1, wherein the tower embodiment is an embodiment selected from the group consisting of: gravity-based structure, piled jacket, jacket-monopile hybrid, harvest jacket, gravity-pile structure, tripod, monopile, supported monopile, bucket suction pile, guided tower, suction bucket, lattice tower, floater, and tension leg platform.

9. The tower of claim 1, wherein the movable tubular member is retracted from an elevated operating mode to a retracted service mode in less than 90 minutes.

10. A tower for supporting a wind turbine, wherein the tower may be elevated or retracted, the tower comprising:
a platform with an upper central structure extending into a void in the seabed under the platform and a lower outboard structure disposed a predefined lateral distance away from a centerline of the platform, the lower outboard structure supporting substantially all the weight of the wind turbine;
a movable tubular member, wherein the movable tubular member may be extended from, or retracted into, the upper central structure and the void, wherein the movable tubular member extends into the void in the seabed, when in a retracted position; and
a locking assembly capable of maintaining an attachment between the movable tubular member and the upper central structure.

11. The tower of claim 10, wherein a gear rack is attached to the movable tubular member.

12. The tower of claim 10, wherein the locking assembly comprises a pall assembly.

13. The tower of claim 10 on which a wind turbine is mounted.

14. The tower of claim 10, further comprising a hydraulic motor that powers elevation or retraction of the movable tubular member and wherein hydraulic power is provided to the hydraulic motor through hydraulic lines from a service vessel.

15. The tower of claim 10, wherein a lower end of the upper central structure is a sealed caisson.

16. The tower of claim 10, wherein the tower embodiment is an embodiment selected from the group consisting of: gravity-based structure, piled jacket, jacket-monopile hybrid, harvest jacket, gravity-pile structure, tripod, monopile, supported monopile, bucket suction pile, guided tower, suction bucket, lattice tower, floater, and tension leg platform.

17. The tower of claim 10, wherein the movable tubular member is retracted from an elevated operating mode to a retracted service mode in less than 90 minutes.

18. A tower for supporting a wind turbine, wherein the tower may be elevated or retracted, the tower comprising:
a platform with an upper central structure and a lower outboard structure disposed a predefined lateral distance away from a centerline of the platform, the lower outboard structure supporting substantially all the weight of the wind turbine, and the upper central structure is a sealed caisson extending below a mudline and into a void in the seabed under the platform;
a movable tubular member configured to be extended from the upper central structure and the void when in an elevated operating mode and retracted into the upper central structure and the void in the seabed when in a retracted service mode such that at least a portion of the movable tubular member is located below the mudline in the retracted service mode;
a locking assembly comprising a pall assembly capable of maintaining an attachment or an alignment between the movable tubular member and the upper central structure; and
a gear rack is attached to the movable tubular member;
wherein the movable tubular member is retracted from an elevated operating mode to a retracted service mode in less than 90 minutes.
